(19) United States
(12) Patent Application Publication
(10) Pub. No.: US 2026/0084997 A1
(43) Pub. Date: Mar. 26, 2026

(54) METHOD FOR PRODUCING OPTICAL FIBER PREFORM, AND OPTICAL FIBER PREFORM

(71) Applicant: SUMITOMO ELECTRIC INDUSTRIES, LTD., Osaka (JP)

(72) Inventors: Hirotaka SAKUMA, Osaka (JP); Yuki KAWAGUCHI, Osaka (JP); Shin SATO, Osaka (JP); Tetsuya HARUNA, Osaka (JP)

(21) Appl. No.: 19/106,254

(22) PCT Filed: Aug. 21, 2023
(86) PCT No.: PCT/JP2023/030043

§ 371 Date: Feb. 25, 2025

(30) Foreign Application Priority Data
Aug. 29, 2022 (JP) 2022-135668

(51) Int. Cl. C03B 37/012; C03B 37/014

(52) U.S. Cl. CPC C03B 37/01222; C03B 37/01248; C03B 37/01262; C03B 37/014

(57) ABSTRACT

The method for manufacturing an optical fiber preform, the method includes: doping at least one element selected from an alkali metal group into a first glass pipe; collapsing the first glass pipe, thereby obtaining a glass rod; and performing at least one rod-in-collapse. The collapsing and the performing the at least one rod-in-collapse are performed while traversing an external heat source in a first direction from a first end toward a second end of the glass rod or in a second direction from the second end toward the first end. In the collapsing and the performing the at least one rod-in-collapse, a difference between the number of times of the traversing in the first direction and the number of times of the traversing in the second direction is 1 or less.

### TECHNICAL FIELD

The present disclosure relates to a method for manufacturing an optical fiber preform and an optical fiber preform. This application claims priority from Japanese Patent Application No. 2022-135668 filed on Aug. 29, 2022, and the entire contents of which are incorporated herein by reference.

### BACKGROUND ART

When a core portion formed of silica-based glass contains an alkali metal element or an alkaline earth metal element, the viscosity of the core is reduced and the rearrangement of glass is promoted when an optical fiber is manufactured by drawing an optical fiber preform. Thus, the transmission loss caused by Rayleigh scattering of the optical fiber is reduced. As a result, the transmission loss can be reduced.

Each of Patent literature 1, Patent literature 2, and Patent literature 3 describes a method of doping an alkali metal element or an alkaline earth metal element into a core portion of an optical fiber preform by diffusion method.

### CITATION LIST

### Patent Literature

Patent literature 1: WO 2004/020357
Patent literature 2: WO 2005/021455
Patent literature 3: WO 2013/111470

### SUMMARY OF INVENTION

A method for manufacturing an optical fiber preform according to an aspect of the present disclosure includes: doping at least one element selected from an alkali metal group consisting of an alkali metal element and an alkaline earth metal element into an inner surface of a first glass pipe formed of silica-based glass; collapsing the first glass pipe after the doping by heating, thereby obtaining a glass rod; and performing at least one rod-in-collapse, the at least one rod-in-collapse including insertion of a rod including the glass rod into a second glass pipe and integration of the rod and the second glass pipe by heating. The collapsing and the performing the at least one rod-in-collapse are performed while traversing an external heat source in a first direction from a first end toward a second end of the glass rod or in a second direction from the second end toward the first end. In the collapsing and the performing the at least one rod-in-collapse, a difference between the number of times of the traversing in the first direction and the number of times of the traversing in the second direction is 1 or less.

### BRIEF DESCRIPTION OF THE DRAWINGS

FIG. 1 is a cross-sectional view orthogonal to a longitudinal direction of an optical fiber preform according to a first embodiment.

FIG. 2 is a flowchart showing a method for manufacturing an optical fiber preform according to a first embodiment.

FIG. 3 is a diagram explaining a doping step.

FIG. 4 is a cross-sectional view taken along a longitudinal direction of an optical fiber preform according to a first embodiment.

FIG. 5 is a cross-sectional view taken along a longitudinal direction of an optical fiber preform according to a first comparative example.

FIG. 6 is a cross-sectional view orthogonal to a longitudinal direction of an optical fiber preform according to a second embodiment.

FIG. 7 is a flowchart showing a method for manufacturing an optical fiber preform according to a second embodiment.

### DETAILED DESCRIPTION

### Problems to be Solved by Present Disclosure

In the method for manufacturing an optical fiber preform, collapse may be performed a plurality of times, including when manufacturing a core rod doped with an alkali metal element or an alkaline earth metal element. The viscosity of a glass portion to which an alkali metal element or an alkaline earth metal element is doped (hereinafter, referred to as an alkali-doped portion) is decreased. When the collapse is performed, the alkali-doped portion has a low viscosity, and thus may be crushed by application of an external force. Thus, a diameter of the alkali-doped portion may increase or decrease depending on the location in a longitudinal direction. In particular, in a terminal end portion of traversing in the collapse, the increase in the diameter of the alkali-doped portion may be significant.

When the diameter of the alkali-doped portion increases or decreases, a concentration of the alkali metal element or the alkaline earth metal element in the cross section increases or decreases when formed into a fiber. The Rayleigh scattering loss depends on the concentration of the alkali metal element or the alkaline earth metal element. Thus, if the concentration of the alkali metal element or the alkaline earth metal element cannot be controlled, the transmission loss cannot be controlled with high accuracy as a result, and there is a concern that defects may increase.

An object of the present disclosure is to provide a method for manufacturing an optical fiber preform and an optical fiber preform capable of suppressing a variation in a concentration of an alkali metal group in a longitudinal direction.

### Advantageous Effects of Present Disclosure

According to the present disclosure, it is possible to provide a method for manufacturing an optical fiber preform and an optical fiber preform capable of suppressing a variation in a concentration of an alkali metal group in a longitudinal direction.

### Description of Embodiments of Present Disclosure

First, embodiments of the present disclosure will be listed and described. (1) A method for manufacturing an optical fiber preform according to an aspect of the present disclosure includes: doping at least one element selected from an alkali metal group consisting of an alkali metal element and an alkaline earth metal element into an inner surface of a first glass pipe formed of silica-based glass; collapsing the first glass pipe after the doping by heating, thereby obtaining a glass rod; and performing at least one rod-in-collapse, the at least one rod-in-collapse including insertion of a rod including the glass rod into a second glass pipe and integration of the rod and the second glass pipe by heating. The collapsing and the performing the at least one rod-in-collapse are performed while traversing an external heat source in a first direction from a first end toward a second end of the glass rod or in a second direction from the second end toward the first end. In the collapsing and the performing the at least one rod-in-collapse, a difference between the number of times of the traversing in the first direction and the number of times of the traversing in the second direction is 1 or less. In this method for manufacturing an optical fiber preform, it is possible to suppress a variation in a diameter of an alkali-doped portion in a longitudinal direction. Thus, a variation in a concentration of the alkali metal group in the longitudinal direction can be suppressed.

(2) In the above (1), the traversing in the first direction and the traversing in the second direction may be alternately performed in the collapsing and the performing the at least one rod-in-collapse. In this case, it is possible to reliably suppress the variation in the diameter of the alkali-doped portion in the longitudinal direction.

(3) In the above (1) or (2), the method for manufacturing an optical fiber preform may be a method for manufacturing a multi-core optical fiber preform including a plurality of core portions. In the collapsing and the performing the at least one rod-in-collapse, a difference between the number of times of the traversing in the first direction and the number of times of the traversing in the second direction may be 1 or less for each of the plurality of core portions. In this case, it is possible to suppress the variation in the diameter of the alkali-doped portion in the longitudinal direction for each of the core portions. Thus, when formed into a fiber, a variation in transmission loss in the longitudinal direction can be suppressed for each of the cores.

(4) The method for manufacturing an optical fiber preform according to any one of the above (1) to (3) may further include providing a glass layer on an outer side of the rod including the glass rod by a method other than a rod-in-collapse method. In this case, since the rod-in-collapse method is not used, the diameter of the alkali-doped portion in the longitudinal direction is less likely to vary.

(5) The method for manufacturing an optical fiber preform according to any one of the above (1) to (3) may further include providing a glass layer on an outer side of the rod including the glass rod by an OVD method or a VAD method. In this case, unlike the rod-in-collapse method, the diameter of the alkali-doped portion in the longitudinal direction is less likely to vary.

(6) In any one of the above (1) to (5), at least one element selected from a group consisting of sodium, potassium, rubidium, and cesium may be doped as the alkali metal group in the doping. In this case, a transmission loss caused by Rayleigh scattering of an optical fiber is reliably reduced.

(7) An optical fiber preform according to an aspect of the present disclosure is an optical fiber preform doped with at least one element selected from an alkali metal group consisting of an alkali metal element and an alkaline earth metal element. The optical fiber preform includes an end portion and a center portion in a longitudinal direction. A difference between a concentration of the at least one element in the end portion and a concentration of the at least one element in the center portion is less than 15% in mass fraction. In this optical fiber preform, the variation in the concentration of the alkali metal group in the longitudinal direction can be suppressed.

(8) In the above (7), a concentration of the alkali metal group in the end portion may be higher than a concentration of the alkali metal group in the center portion. In this case, the transmission loss in the end portion is equal to or smaller than the transmission loss in the center portion. Thus, the risk of a decrease in manufacturing yield due to an increase in the transmission loss in mass production is small.

### Details of Embodiments of Present Disclosure

Specific examples of a method for manufacturing an optical fiber preform and an optical fiber preform of the present disclosure will be described below with reference to the drawings. The present disclosure is not limited to these examples, but is defined by the scope of the claims, and is intended to include all modifications within the meaning and scope equivalent to the scope of the claims. In the description of the drawings, the same elements are denoted by the same reference numerals, and redundant description will be omitted.

### First Embodiment

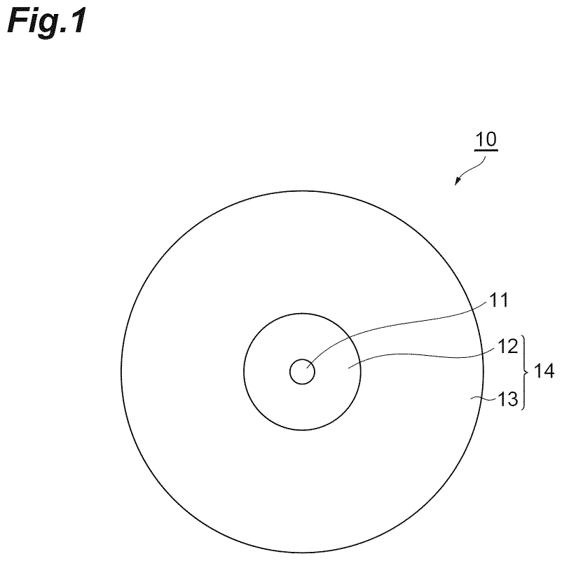

FIG. 1 is a cross-sectional view orthogonal to a longitudinal direction of an optical fiber preform according to a first embodiment. As shown in FIG. 1, an optical fiber preform 10 according to the first embodiment includes a core portion 11, a first cladding portion 12, and a second cladding portion 13. First cladding portion 12 and second cladding portion 13 constitute a cladding portion 14.

Core portion 11 is formed of silica-based glass. Core portion 11 includes chlorine, fluorine, and at least one element selected from an alkali metal group consisting of alkali metal elements and alkaline earth metal elements. The alkali metal group includes, for example, sodium (Na), potassium (K), rubidium (Rb), cesium (Cs), and calcium (Ca). Core portion 11 includes, for example, at least one selected from a group consisting of sodium, potassium, rubidium, and cesium as the alkali metal group. A concentration of other dopants and impurities contained in core portion 11 is 10 ppm or less in mass fraction.

A ratio of silica glass which is a main component of the silica-based glass may be 50% or more, 90% or more, 95% or more, 98% or more, or 99% or more in terms of mass ratio. Here, the mass ratio means mass fraction.

First cladding portion 12 is provided on an outer side of core portion 11 and surrounds core portion 11. First cladding portion 12 is formed of silica-based glass. First cladding portion 12 contains fluorine. A refractive index of first cladding portion 12 is lower than a refractive index of core portion 11.

Second cladding portion 13 is provided on an outer side of first cladding portion 12 and surrounds first cladding portion 12. Second cladding portion 13 is formed of silica-based glass. Second cladding portion 13 contains fluorine. A refractive index of second cladding portion 13 is lower than the refractive index of core portion 11 and higher than the refractive index of first cladding portion 12.

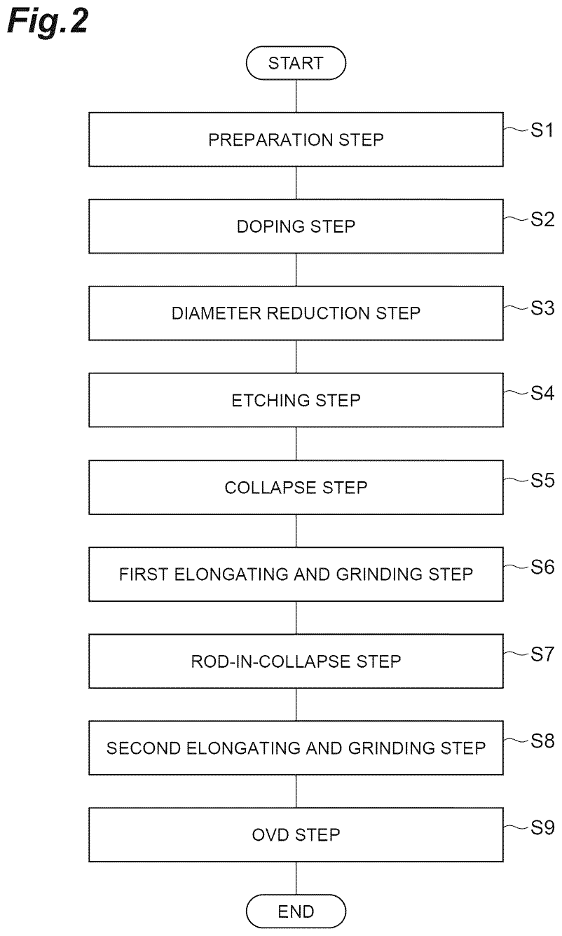

FIG. 2 is a flowchart showing a method for manufacturing an optical fiber preform according to the first embodiment. As shown in FIG. 2, the method for manufacturing optical fiber preform 10 according to the first embodiment includes a preparation step S1, a doping step S2, a diameter reduction step S3, an etching step S4, a collapse step S5, a first elongating and grinding step S6, a rod-in-collapse step S7, a second elongating and grinding step S8, and an OVD (Outside Vapor Deposition) step S9. Optical fiber preform 10 is manufactured by the step S1 to the step S9. Further, a drawing step (not shown) is performed to manufacture an optical fiber.

In the preparation step S1, a glass pipe 1 (see FIG. 2) of silica-based glass in which a dopant such as an alkali metal group is to be diffused is prepared. Glass pipe 1 contains chlorine and fluorine at a certain concentration, and the mass fraction of other dopants and impurities is 10 ppm or less (hereinafter, the mass fraction is referred to as “concentration”). An outer diameter of glass pipe 1 is 30 mm to 50 mm, and an inner diameter is 10 mm to 30 mm.

Glass pipe 1 contains chlorine in an average concentration of 0 ppm to 1500 ppm and fluorine in an average concentration of 500 ppm to 5000 ppm. Here, the average concentration is, for example, the concentration represented by the following equation in the case of the average chlorine concentration. Cl(r) represents a local chlorine concentration at a position of a radius r. The inner diameter of glass pipe 1 is represented by i, and the outer diameter of glass pipe 1 is represented by d. The calculation is performed in the same manner for fluorine and other dopants. In the case of the glass rod, the calculation is performed with i being 0 and d being the outer diameter of the glass rod.

$$\frac{2 {\int }_{i}^{d} Cl ( r ) \cdot r \cdot dr}{{d}^{2} - {i}^{2}} \qquad [ Equation 1 ]$$

The method for measuring the local concentration is as follows. The chlorine concentration is measured by an electron probe micro analyzer (EPMA) at each position along a straight line passing through the center position on a certain end surface of glass pipe 1 and the glass rod. The conditions of the measurement by EPMA are, for example, acceleration voltage of 20 kV, probe beam diameter of 1 μm or less, and measurement interval of 100 nm or less.

In the doping step S2, at least one element selected from an alkali metal group is doped as a dopant to an inner surface of glass pipe 1 (first glass pipe) formed of silica-based glass. In the doping step S2, at least one selected from a group consisting of sodium, potassium, rubidium, and cesium, for example, is doped as the alkali metal group. Here, the case of doping a potassium (K) element will be described. As a source material, for example, potassium bromide (KBr) 6 g to 20 g is used. Depending on the type of the alkali metal group to be doped, one or more of KBr, KI, RbBr, RbI, and the like may be used as the source material.

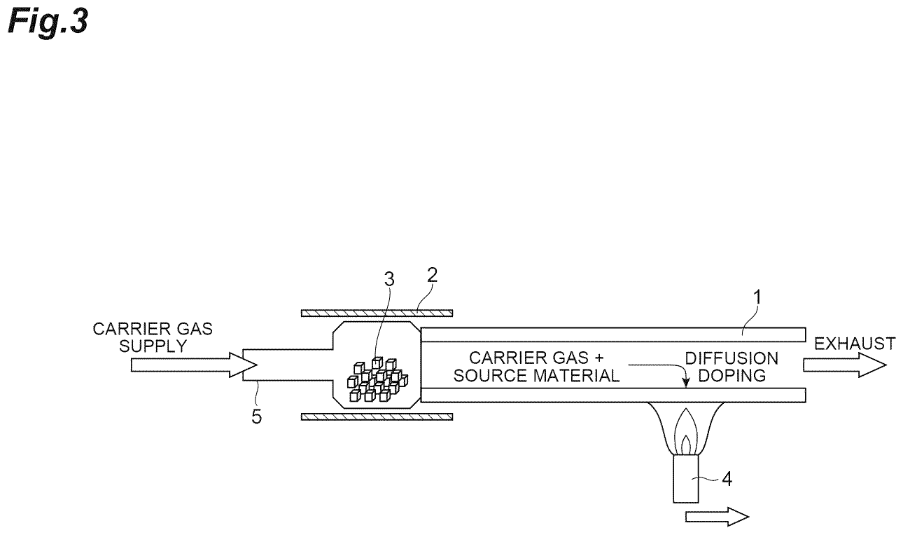

FIG. 3 is a diagram explaining the doping step. As shown in FIG. 3, a handling glass pipe 5 disposed in an electric furnace 2 is connected to one end of glass pipe 1. A part of handling glass pipe 5 is used as a source material reservoir, and a source material 3 is placed therein. Apart of glass pipe 1 may be used as a source material reservoir. An oxyhydrogen burner 4 is disposed outside glass pipe 1. Electric furnace 2 is an external heat source for heating source material 3. Oxyhydrogen burner 4 is an external heat source for heating glass pipe 1. Instead of oxyhydrogen burner 4, an induction furnace, a resistance furnace, or the like may be used.

Source material 3 is heated to a temperature of 700° C. to 850° C. by electric furnace 2 to generate source material vapor. Glass pipe 1 is heated from the outside by oxyhydrogen burner 4 while introducing the generated source material vapor into glass pipe 1 together with a carrier gas composed of oxygen. The flow rate of the carrier gas is set to 1 SLM (1 liter/min in terms of standard conditions (25° C., 100 kPa)) to 3 SLM. The heating of glass pipe 1 is performed by traversing oxyhydrogen burner 4 at a speed of 30 mm/min to 60 mm/min for a total of 8 turns to 15 turns so that the temperature of an outer surface of glass pipe 1 becomes 1400° C. to 2000° C. Thus, the potassium element is diffused and doped into the inner surface of glass pipe 1.

In the diameter reduction step S3, glass pipe 1 doped with the potassium element is reduced in diameter. At this time, glass pipe 1 is heated by the external heat source so that the outer surface of glass pipe 1 becomes 2000° C. to 2300° C. while flowing oxygen into glass pipe 1 in a range of 0.5 SLM to 1.0 SLM. Glass pipe 1 is heated by traversing the external heat source for a total of 6 turns to 10 turns, and the inner diameter of glass pipe 1 is reduced to 3 mm to 5 mm.

In the etching step S4, the inner surface of glass pipe 1 is etched. At this time, vapor phase etching is performed by heating glass pipe 1 with the external heat source while introducing a mixture gas of SF₆ (0.2 SLM to 1.0 SLM) and chlorine (0.5 SLM to 1.0 SLM) into glass pipe 1. In this manner, the inner surface of glass pipe 1 containing impurities doped together with the target dopant at a high concentration can be scraped, and the impurities can be removed. Each step from the preparation step S1 to the etching step S4 constitutes a diffusion doping step for diffusing and doping a dopant into glass pipe 1.

In the collapse step S5, a glass rod is obtained from glass pipe 1 after the doping step S2 by a collapse method. That is, glass pipe 1 after the doping step S2 is collapsed by heating, thereby obtaining a glass rod. For example, a mixture gas of oxygen (0.1 SLM to 0.5 SLM) and He (0.5 SLM to 1.0 SLM) is introduced into glass pipe 1, and glass pipe 1 is closed and collapsed by setting the surface temperature to 2000° C. to 2300° C. while reducing the absolute pressure in glass pipe 1 to 97 kPa or less. Thus, the glass rod having an outer diameter of 20 mm to 40 mm is obtained. In the collapse step S5, glass pipe 1 is collapsed by heating while moving the heat source. The movement of the heat source during the collapse is particularly called traversing in this specification.

In the elongating and grinding step S6, the glass rod obtained in the collapse step S5 is elongated to have a diameter of 20 mm to 25 mm, and an outer peripheral portion of the glass rod is further ground to have a diameter of 15 mm to 25 mm. Thus, core portion 11 of optical fiber preform 10 is obtained. That is, each step from the preparation step S1 to the elongating and grinding step S6 constitutes a core portion manufacturing step for manufacturing core portion 11.

In the rod-in-collapse step S7, first cladding portion 12 is provided on the outer side of core portion 11 by the rod-in-collapse method. That is, core portion 11 is inserted into a glass pipe (second glass pipe) serving as first cladding portion 12, and core portion 11 and the glass pipe are integrated by heating. In this case, a glass pipe of silica-based glass to which fluorine is doped is used. Core portion 11 is used as a rod including the glass rod obtained in the collapse step S5. A relative-refractive index difference between core portion 11 and first cladding portion 12 is about 0.34% at the maximum. In the present embodiment, the relationship of the relative-refractive index difference is the same between the state of optical fiber preform 10 and the state of the optical fiber. As a result of the addition of first cladding portion 12 by the rod-in-collapse method, it is possible to suppress the water content of core portion 11 and first cladding portion 12 in the vicinity thereof to be sufficiently low. In the rod-in-collapse step S7, collapse is performed to integrate the glass pipe and the glass rod as described above while moving the heat source. The movement of the heat source during the collapse is particularly called traversing in this specification.

In the OVD step S8, the rod formed by integrating core portion 11 and first cladding portion 12 is elongated to have a predetermined diameter, and then second cladding portion 13, which is a glass layer containing fluorine, is synthesized on the outer side of the rod by the OVD method. The OVD step S8 can be said to be a step of providing a glass layer on an outer side of the glass rod obtained in the collapse step S5 by the OVD method which is a method other than the collapse method. Thus, optical fiber preform 10 is manufactured. A vapor-phase axial deposition (VAD) method may be used instead of the OVD method.

An optical fiber can be manufactured by a drawing step of drawing optical fiber preform 10. The drawing speed is, for example, 800 m/min to 2300 m/min. The drawing tension is, for example, 0.5 N.

The step S5 and the step S7 are performed while traversing the external heat source in a first direction from a first end toward a second end of the glass rod obtained in the step S5 or in a second direction from the second end toward the first end of the glass rod. When the external heat source is traversed in the first direction, the first end side of the glass rod is a start end of the collapse, and the second end side of the glass rod is a terminal end of the collapse. In the step S5 and the step S7, the start ends of the collapses are different from each other, and the terminal ends of the collapses are different from each other.

In the two times of collapses consisting of the step S5 and the step S7, a difference between the number of times of the traversing in the first direction and the number of times of the traversing in the second direction is 1 or less. For example, in the step S5 and the step S7, the traversing in the first direction and the traversing in the second direction are alternately performed. That is, when the traversing in the first direction is performed in the step S5, the traversing in the second direction is performed in the step S7. When the traversing in the second direction is performed in the step S5, the traversing in the first direction is performed in the step S7.

The external heat source is used to heat glass pipe 1 serving as core portion 11 and the glass pipe serving as first cladding portion 12 from the outer side. The external heat source may be the same as oxyhydrogen burner 4 used in the doping step S2, for example. The same external heat source may be used in the step S5 and the step S7.

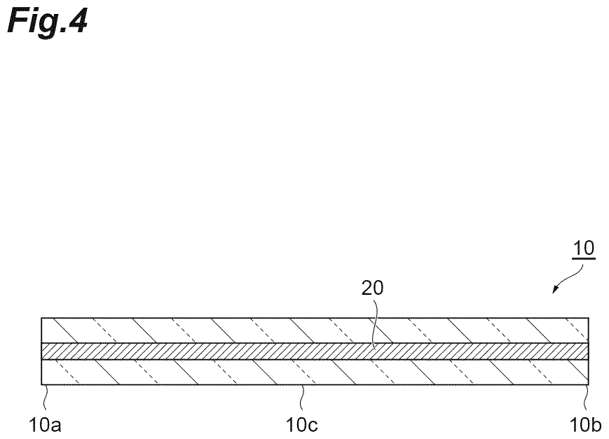

FIG. 4 is a cross-sectional view taken along the longitudinal direction of the optical fiber preform according to the first embodiment. As shown in FIG. 4, optical fiber preform 10 has a first end portion 10a, a second end portion 10b, and a center portion 10c in the longitudinal direction. Center portion 10c is located between first end portion 10a and second end portion 10b. First end portion 10a configured to include the first end of the glass rod obtained in the step S5. Second end portion 10b configured to include the second end of the glass rod obtained by the step S5.

Optical fiber preform 10 includes an alkali-doped portion 20 to which at least one element selected from an alkali metal group is doped. In FIG. 4, alkali-doped portion 20 is conceptually shown. Alkali-doped portion 20 is disposed at the center of the cross section orthogonal to the longitudinal direction of optical fiber preform 10, and extends along the longitudinal direction.

A diameter of alkali-doped portion 20 in first end portion 10a is equal to a diameter of alkali-doped portion 20 in second end portion 10b. The diameters of alkali-doped portions 20 in first end portion 10a and second end portion 10b are equal to a diameter of alkali-doped portion 20 in center portion 10c or longer than the diameter of alkali-doped portion 20 in center portion 10c.

The diameter of alkali-doped portion 20 has a correlation with a concentration of the alkali metal group. Thus, a concentration of the alkali metal group in first end portion 10a is equal to a concentration of the alkali metal group in second end portion 10b. The concentrations of the alkali metal group in first end portion 10a and second end portion 10b are equal to a concentration of the alkali metal group in center portion 10c or higher than the concentration of the alkali metal group in center portion 10c. A difference between the concentrations of the alkali metal group in first end portion 10a and second end portion 10b and the concentration of the alkali metal group in center portion 10c is less than 15% in mass fraction, and more preferably 5% or less.

### First Comparative Example

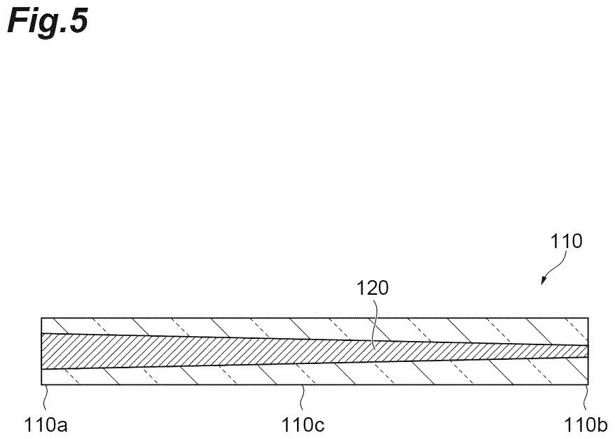

FIG. 5 is a cross-sectional view taken along a longitudinal direction of an optical fiber preform according to a first comparative example. As shown in FIG. 5, an optical fiber preform 110 according to the first comparative example is different from optical fiber preform 10 in that optical fiber preform 110 has an alkali-doped portion 120 whose diameter increases from a second end portion 110b toward a first end portion 110a. A diameter of alkali-doped portion 120 in first end portion 110a is larger than a diameter of alkali-doped portion 120 in second end portion 110b. That is, a concentration of the alkali metal group in first end portion 110a is higher than a concentration of the alkali metal group in second end portion 110b.

A method for manufacturing optical fiber preform 110 according to the first comparative example is different from the method for manufacturing according to the first embodiment in that the direction of traversing the external heat source is not reversed in the step S5 and the step S7. That is, in both of the step S5 and the step S7, the direction of traversing the external heat source is the same, and the external heat source is traversed in the first direction or the second direction. In the step S5 and the step S7, the start ends of the collapses coincide with each other, and the terminal ends of the collapses coincide with each other. In this example, the traversing in the first direction is performed in both of the step S5 and the step S7.

### Second Embodiment

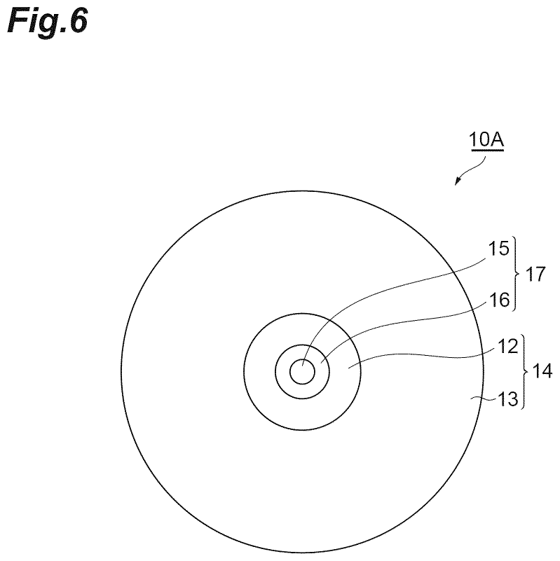

FIG. 6 is a cross-sectional view orthogonal to a longitudinal direction of an optical fiber preform according to a second embodiment. As shown in FIG. 6, an optical fiber preform 10A according to the second embodiment includes a first core portion 15, a second core portion 16, first cladding portion 12, and second cladding portion 13. First core portion 15 and second core portion 16 constitute a core portion 17. First cladding portion 12 and second cladding portion 13 constitute cladding portion 14.

First core portion 15 has a configuration equivalent to that of core portion 11 of optical fiber preform 10. Second core portion 16 is provided on an outer side of first core portion 15 and surrounds first core portion 15. Second core portion 16 is formed of silica-based glass. Second core portion 16 contains chlorine and fluorine, but does not contain an alkali metal group. First cladding portion 12 is different from first cladding portion 12 of optical fiber preform 10 in that first cladding portion 12 is provided on an outer side of second core portion 16 and surrounds second core portion 16, and has a configuration equivalent to that of first cladding portion 12 of optical fiber preform 10 in other respects. Second cladding portion 13 has a configuration equivalent to that of second cladding portion 13 of optical fiber preform 10.

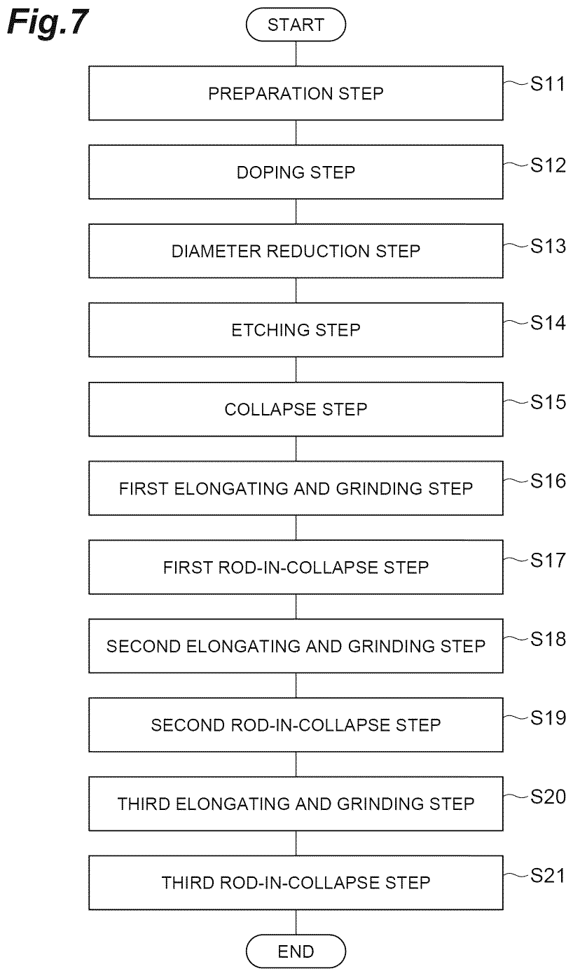

FIG. 7 is a flowchart showing a method for manufacturing an optical fiber preform according to the second embodiment. As shown in FIG. 7, the method for manufacturing optical fiber preform 10A according to the second embodiment includes a preparation step S11, an doping step S12, a diameter reduction step S13, an etching step S14, a collapse step S15, a first elongating and grinding step S16, a first rod-in-collapse step S17, a second elongating and grinding step S18, a second rod-in-collapse step S19, a third elongating and grinding step S20, and a third rod-in-collapse step S21. Optical fiber preform 10A is manufactured by the step S11 to the step S21. Further, a drawing step (not shown) is performed to manufacture an optical fiber.

Since the step S11 to the step S16 are substantially equal to the step S1 to the step S6 of the first embodiment, respectively, and thus the description thereof will be omitted. First core portion 15 is obtained by the step S11 to the step S16.

In the first rod-in-collapse step S17, second core portion 16 is provided on the outer side of first core portion 15 by the rod-in-collapse method. That is, first core portion 15 is inserted into a glass pipe (first second glass pipe) serving as second core portion 16, and first core portion 15 and the glass pipe are integrated by heating. In this case, a glass pipe of silica-based glass to which chlorine and fluorine are doped is used. First core portion 15 is used as a rod including the glass rod obtained in the collapse step S15.

In the second elongating and grinding step S18, the glass rod obtained in the first rod-in-collapse step S17 is elongated to have a diameter of 20 mm to 25 mm, and an outer peripheral portion of the glass rod is ground to have a diameter of 15 mm to 25 mm. Thus, core portion 17 of optical fiber preform 10A is obtained. That is, each step from the preparation step S1 to the second elongating and grinding step S18 constitutes a core portion manufacturing step for manufacturing core portion 17.

In the second rod-in-collapse step S19, first cladding portion 12 is provided on an outer side of core portion 17 by the rod-in-collapse method. That is, core portion 17 is inserted into a glass pipe (second second glass pipe) serving as first cladding portion 12, and core portion 17 and the glass pipe are integrated by heating. In this case, a glass pipe of silica-based glass to which fluorine is doped is used. Core portion 17 is used as a rod including the glass rod obtained in the collapse step S15.

In the third elongating and grinding step S20, the glass rod obtained in the second rod-in-collapse step S19 is elongated to have a diameter of 20 mm to 35 mm, and an outer peripheral portion of the glass rod is ground to have a diameter of 15 mm to 25 mm.

In the third rod-in-collapse step S21, second cladding portion 13 is provided on an outer side of the glass rod consisting of core portion 17 and first cladding portion 12 by the rod-in-collapse method. That is, the glass rod consisting of core portion 17 and first cladding portion 12 is inserted into a glass pipe (second second glass pipe) serving as second cladding portion 13, and the glass pipe and the glass rod including core portion 17 and first cladding portion 12 are integrated by heating. In this case, a glass pipe of silica-based glass to which fluorine is doped is used. The glass rod including core portion 17 and first cladding portion 12 is used as a rod including the glass rod obtained in the collapse step S15. Thus, optical fiber preform 10A is manufactured.

An optical fiber can be manufactured by a drawing step of drawing optical fiber preform 10A. The drawing speed is, for example, 800 m/min to 2300 m/min. The drawing tension is, for example, 0.5 N.

The step S15, the step S17, the step S19, and the step S21 are performed while traversing the external heat source in a first direction from a first end toward a second end of the glass rod obtained in the step S15 or in a second direction from the second end toward the first end of the glass rod.

In the four times of collapses consisting of the step S15, the step S17, the step S19, and the step S21, a difference between the number of times of the traversing in the first direction and the number of times of the traversing in the second direction is 1 or less. For example, in the step S15, the step S17, the step S19, and the step S21, the traversing in the first direction and the traversing in the second direction are alternately performed.

In the four times of collapses consisting of the step S15, the step S17, the step S19, and the step S21, the direction of traversing the external heat source is reversed. For example, the traversing in the first direction is performed in the step S15, the traversing in the second direction is performed in the step S17, the traversing in the first direction is performed in the step S19, and the traversing in the second direction is performed in the step S21.

In optical fiber preform 10A according to the second embodiment, alkali-doped portion 20 (see FIG. 4) having a small variation in the outer diameter is formed as in optical fiber preform 10. Thus, in optical fiber preform 10A, as in optical fiber preform 10, the concentrations of the alkali metal group in first end portion 10a (see FIG. 4) and second end portion 10b (see FIG. 4) are equal to the concentration of the alkali metal group in center portion 10c (see FIG. 4) or higher than the concentration of the alkali metal group in center portion 10c. A difference between the concentrations of the alkali metal group in first end portion 10a and second end portion 10b and the concentration of the alkali metal group in center portion 10c is less than 15% in mass fraction, and more preferably 5% or less.

### Second Comparative Example

A method for manufacturing according to a second comparative example is different from the method for manufacturing according to the second embodiment in that the direction of traversing the external heat source is not reversed in the step S15, the step S17, the step S19, and the step S21. That is, the traversing in the same direction is performed in any of the step S15, the step S17, the step S19, and the step S21. In this example, the traversing in the first direction is performed in any of the step S15, the step S17, the step S19, and the step S21.

In the optical fiber preform according to the second comparative example, as in optical fiber preform 110 according to the first comparative example, alkali-doped portion 120 (see FIG. 5), whose diameter increases from second end portion 110b (see FIG. 5) toward first end portion 110a (see FIG. 5) is formed. Thus, in the optical fiber preform according to the second comparative example, as in optical fiber preform 110, the diameter of alkali-doped portion 120 in first end portion 110a is larger than the diameter of alkali-doped portion 120 in second end portion 110b. That is, the concentration of the alkali metal group in first end portion 110a is higher than the concentration of the alkali metal group in second end portion 110b.

### Experimental Example

Hereinafter, experimental examples will be described.

In a first experimental example, an optical fiber preform was manufactured by the method for manufacturing according to the first comparative example, and an optical fiber was manufactured by further performing the drawing step. That is, in the first experimental example, the collapses consisting of the step S5 and the step S7 were performed twice in total. In any of the step S5 and the step S7, the traversing in the first direction was performed.

In a second experimental example, an optical fiber preform was manufactured by the method for manufacturing according to the first embodiment, and an optical fiber was manufactured by further performing the drawing step. That is, in the second experimental example, the collapses consisting of the step S5 and the step S7 were performed twice in total. In the step S5, the traversing in the first direction was performed, and in the step S7, the traversing in the second direction was performed.

In a third experimental example, an optical fiber preform was manufactured by the method for manufacturing according to the second comparative example, and an optical fiber was manufactured by further performing the drawing step. That is, in the third experimental example, the collapses consisting of the step S15, the step S17, the step S19, and the step S21 were performed four times in total. In any of the step S15, the step S17, the step S19, and the step S21, the traversing in the first direction was performed.

In a fourth experimental example, an optical fiber preform was manufactured by the method for manufacturing according to the second embodiment, and an optical fiber was manufactured by further performing the drawing step. That is, in the fourth experimental example, the collapses consisting of the step S15, the step S17, the step S19, and the step S21 were performed four times in total. In each of the step S15 and the step S19, the traversing in the first direction was performed. In each of the step S17 and the step S21, the traversing in the second direction was performed.

Each optical fiber according to the each experimental example was manufactured so that the effective area (Aeff) was 105 μm² to 115 μm², the cutoff wavelength kc was 1400 nm to 1520 nm, and the relative refractive index difference (relative-refractive index difference) between the core and the cladding was 0.340±0.0100. Here, the “relative refractive index difference between the core and the cladding” is the relative refractive index difference between the core and the first cladding in each case of ethe first experimental example and the second experimental example, and is the relative refractive index difference between the second core and the first cladding in each case of the third experimental example and the fourth experimental example.

For each optical fiber preforms according to each experimental example, the concentration of the potassium element in each of the first end portion, the center portion, and the second end portion was measured using the above-described EPMA. The transmission loss at a wavelength of 1550 nm was measured for each optical fiber drawn from each of the first end portion, the center portion, and the second end portion of each optical fiber preform according to each experimental example.

Table 1 is a table in which specifications and conditions of the optical fiber preforms and the optical fibers according to all experimental examples are summarized.

TABLE 1

| | | First | Second | Third | Fourth |
|---|---|---|---|---|---|
| | | experimental | experimental | experimental | experimental |
| | | example | example | example | example |
| Transmission | First end | 0.146 | 0.147 | 0.145 | 0.147 |
| loss | portion | | | | |
| [dB/km] | Center portion | 0.147 | 0.147 | 0.147 | 0.147 |
| | Second end | 0.149 | 0.147 | 0.150 | 0.147 |
| | portion | | | | |
| K | First end | 60 | 48 | 70 | 44 |
| concentration | portion | | | | |
| [ppm]. | Center portion | 45 | 46 | 45 | 44 |
| | Second end | 30 | 47 | 20 | 46 |
| | portion | | | | |

| | | | | |
|---|---|---|---|---|
| Total number of collapses | 2 | 2 | 4 | 4 |
| Number of times of | 0 | 1 | 0 | 2 |
| traversing in first | | | | |
| direction (first end | | | | |
| to second end) | | | | |
| Number of times of | 2 | 1 | 4 | 2 |
| traversing in second | | | | |
| direction (second | | | | |
| end to first end) | | | | |
| Core diameter [μm] | 11.1 | 11.1 | 11.1 | 11.2 |
| Aeff [μm²]. | 112 | 113 | 111 | 112 |
| λc [nm] | 1481 | 1479 | 1490 | 1481 |

In each of the first experimental example and the third experimental example, the K concentration decreases from the first end portion to the second end portion. Thus, the transmission losses increase from the first end portions to the second end portions. In each of the second experimental example and the fourth experimental example, the K concentration is substantially constant over the entire longitudinal direction by reversing the traverse direction, that is, the collapse direction. Thus, the transmission losses are stable over the entire longitudinal direction.

As described above, in the method for manufacturing according to the above embodiments, the collapsing and the performing the at least one rod-in-collapse are carried out, and in the collapsing and the performing the at least one rod-in-collapse, the difference between the number of times of the traversing in the first direction and the number of times of the traversing in the second direction is 1 or less. This suppresses the increase or decrease in the diameter of alkali-doped portion 120 in the longitudinal direction. Thus, the variation in the concentration of the alkali metal group in the longitudinal direction is suppressed. When the concentration of the alkali metal group is increased or when the diameter of alkali-doped portion 120 is increased, the concentration of the alkali metal group is likely to vary in the longitudinal direction. Although it is conceivable to lower the temperature of the collapse, the melting of an interface may become insufficient, and manufacturing defects may occur. Thus, the method for manufacturing according to the above embodiments in which the collapse direction is reversed is effective.

While the embodiments have been described, the present disclosure is not necessarily limited to the above-described embodiments and modifications, and various changes can be made without departing from the spirit and scope of the present disclosure.

Optical fiber preform 10 may be a multi-core optical fiber preform having a plurality of core portions. In this case, in the step S5 and the step S7, the difference between the number of times of the traversing in the first direction and the number of times of the traversing in the second direction is 1 or less for each of the plurality of core portions. Thus, it is possible to suppress the variation in the concentration of the alkali metal group in the longitudinal direction for each core portion.

Optical fiber preform 10A may be a multi-core optical fiber preform having a plurality of core portions. In this case, in the step S15, the step S17, the step S19, and the step S21, the difference between the number of times of the traversing in the first direction and the number of times of the traversing in the second direction is 1 or less for each of the plurality of core portions. Thus, it is possible to suppress the variation in the diameter of alkali-doped portion 120 in the longitudinal direction for each of the core portions. Thus, when formed into a fiber, the variation in transmission loss in the longitudinal direction can be suppressed for each of the cores.

Optical fiber preform 10, 10A do not have to include second cladding portion 13. That is, the method for manufacturing optical fiber preform 10 does not have to include the OVD step S9. The method for manufacturing optical fiber preform 10A does not have to include the third rod-in-collapse step S21. Optical fiber preform 10, 10A may further include one or more glass layers provided on an outer side of second cladding portion 13. That is, the method for manufacturing optical fiber preform 10, 10A may further include providing a glass layer on the outer side of second cladding portion 13 by a known method such as a rod-in-collapse method, an OVD method, or a VAD method. Even in these cases, in the method for manufacturing optical fiber preform 10, 10A, the collapsing and the performing the at least one rod-in-collapse are carried out, and in the collapsing and the performing the at least one rod-in-collapse, the difference between the number of times of the traversing in the first direction and the number of times of the traversing in the second direction may be 1 or less.

Optical fiber preform 10 may further include one or more glass layers provided on the outer side of core portion 11 and an inner side of first cladding portion 12. That is, the method for manufacturing optical fiber preform 10 may further include providing a glass layer on the outer side of core portion 11 and on the inner side of first cladding portion 12 by a known method such as a rod-in-collapse method, an OVD method, or a VAD method. Optical fiber preform 10A may further include one or more glass layers provided on the outer side of second core portion 16 and on the inner side of first cladding portion 12. That is, the method for manufacturing optical fiber preform 10A may further include providing a glass layer on the outer side of second core portion 16 and on the inner side of first cladding portion 12 by a known method such as a rod-in-collapse method, an OVD method, or a VAD method. Even in these cases, in the method for manufacturing optical fiber preform 10, 10A, the collapsing and the performing the at least one rod-in-collapse are carried out, and in the collapsing and the performing the at least one rod-in-collapse, the difference between the number of times of the traversing in the first direction and the number of times of the traversing in the second direction may be 1 or less.

### REFERENCE SIGNS LIST

1 glass pipe
2 electric furnace
3 source material
4 oxyhydrogen burner
5 handling glass pipe
10, 10A optical fiber preform
10a first end portion
10b second end portion
10c center portion
11 core portion
12 first cladding portion
13 second cladding portion
14 cladding portion
15 first core portion
16 second core portion
17 core portion
110 optical fiber preform
110a first end portion
110b second end portion

What is claimed is:

1. A method for manufacturing an optical fiber preform, the method comprising:
doping at least one element selected from an alkali metal group consisting of an alkali metal element and an alkaline earth metal element into an inner surface of a first glass pipe formed of silica-based glass;
collapsing the first glass pipe after the doping by heating, thereby obtaining a glass rod; and
performing at least one rod-in-collapse, the at least one rod-in-collapse including insertion of a rod including the glass rod into a second glass pipe and integration of the rod and the second glass pipe by heating,
wherein the collapsing and the performing the at least one rod-in-collapse are performed while traversing an external heat source in a first direction from a first end toward a second end of the glass rod or in a second direction from the second end toward the first end, and
wherein, in the collapsing and the performing the at least one rod-in-collapse, a difference between the number of times of the traversing in the first direction and the number of times of the traversing in the second direction is 1 or less.

2. The method for manufacturing an optical fiber preform according to claim 1,
wherein the traversing in the first direction and the traversing in the second direction are alternately performed in the collapsing and the performing the at least one rod-in-collapse.

3. The method for manufacturing an optical fiber preform according to claim 1,
wherein the method is a method for manufacturing a multi-core optical fiber preform including a plurality of core portions, and
wherein, in the collapsing and the performing the at least one rod-in-collapse, a difference between the number of times of the traversing in the first direction and the number of times of the traversing in the second direction is 1 or less for each of the plurality of core portions.

4. The method for manufacturing an optical fiber preform according to claim 1, further comprising:
providing a glass layer on an outer side of the rod including the glass rod by a method other than a rod-in-collapse method.

5. The method for manufacturing an optical fiber preform according to claim 1, further comprising:
providing a glass layer on an outer side of the rod including the glass rod by an OVD method or a VAD method.

6. The method for manufacturing an optical fiber preform according to claim 1,
wherein at least one element selected from a group consisting of sodium, potassium, rubidium, and cesium is doped as the alkali metal group in the doping.

7. An optical fiber preform doped with at least one element selected from an alkali metal group consisting of an alkali metal element and an alkaline earth metal element, the optical fiber preform comprising:
an end portion and a center portion in a longitudinal direction,
wherein a difference between a concentration of the at least one element in the end portion and a concentration of the at least one element in the center portion is less than 15% in mass fraction.

8. The optical fiber preform according to claim 7,
wherein a concentration of the alkali metal group in the end portion is higher than a concentration of the alkali metal group in the center portion.
